(19) United States
(12) Patent Application Publication
(10) Pub. No.: US 2010/0159331 A1
(43) Pub. Date: Jun. 24, 2010

(54) NEGATIVE ACTIVE MATERIAL, NEGATIVE ELECTRODE INCLUDING THE SAME, METHOD OF MANUFACTURING THE NEGATIVE ELECTRODE, AND LITHIUM BATTERY INCLUDING THE NEGATIVE ELECTRODE

(75) Inventors: Jeong-hee Lee, Seongnam-si (KR); In-taek Han, Seoul (KR); Yoon-chul Son, Hwaseong-si (KR); Ho-suk Kang, Seoul (KR); Jeong-na Heo, Yongin-si (KR); Joon-won Bae, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/575,031

(22) Filed: Oct. 7, 2009

(30) Foreign Application Priority Data
Dec. 23, 2008 (KR) 10-2008-0132206

(51) Int. Cl. H01B 1/04; H01M 4/58; B05D 5/12

(52) U.S. Cl. 429/231.8; 252/502; 427/77; 977/742; 977/773

(57) ABSTRACT

A negative active material, a negative electrode including the negative active material, a method of manufacturing the negative electrode, and a lithium battery including the negative electrode. The negative active material includes a composite including a non-carbonaceous material, carbon nanotubes (CNTs), and carbon nanoparticles. The carbon nanoparticles are formed by carbonizing a polymer of carbonizable monomers.

### CROSS-REFERENCE TO RELATED APPLICATION

This application claims the benefit of Korean Patent Application No. 10-2008- 0132206, filed on Dec. 23, 2008, in the Korean Intellectual Property Office, the disclosure of which is incorporated herein, by reference.

### BACKGROUND

1. Field

One or more embodiments of the present teachings relate to a negative active material, a negative electrode including the same, a method of manufacturing the negative electrode, and a lithium battery including the negative electrode.

2. Description of the Related Art

Lithium secondary batteries are used as power sources of small portable electronic devices. Since lithium secondary batteries use an organic electrolytic solution, a discharge voltage thereof is at least twice that of conventional alkaline batteries. Accordingly, lithium secondary batteries have a high energy density.

In lithium secondary batteries, an oxide that includes lithium and a transition material is used as a positive active material. The oxide has a structure that allows lithium ions to be reversibly intercalated therein. Examples of the oxide include LiCoO₂, LiMn₂O₄, and LiN₁₋ₓCoxO₂ (0<x<1).

In lithium secondary batteries, a carbonaceous material that allows lithium to be intercalated and/or deintercalated is used as a negative active material. Examples of the carbonaceous material include artificial graphite, natural graphite, and hard carbon. Recently, research is being performed into the use of non-carbonaceous materials, such as Si, as a negative active material, in order to obtain a high stability and capacity. Although non-carbonaceous materials have 10 times the theoretical capacity of graphite, their cycle lifetimes are short, because lithium batteries swell and shrink when charged and discharged. In addition, since non-carbonaceous materials, such as Si, have low electric conductivities, electrons do not flow smoothly therein, which can result in poor battery performance

To overcome these problems, non-carbonaceous materials, such as Si, can be formed into nanoparticles and can be used together with a carbon material, to form a composite. For the latter case, carbon nanotubes are often used as the carbon material. However, if the composite including the non-carbonaceous material and carbon nanotubes is formed by milling and dispersing, a binding force between the non-carbonaceous material and carbon nanotubes is likely to be reduced when the lithium batteries swell and shrink during charging or discharging, and thus, electrical disconnections may occur and cycle lifetimes may be reduced.

### SUMMARY

One or more embodiments include a negative active material having a long cycle lifetime.

One or more embodiments include a negative electrode including the negative active material.

One or more embodiments include a method of manufacturing the negative electrode.

One or more embodiments include a lithium battery including the negative electrode.

To achieve the above and/or other aspects, one or more exemplary embodiments may include a negative active material including a composite, the composite including a non-carbonaceous material, carbon nanotubes (CNTs), and carbon nanoparticles.

One or more embodiments may include a negative electrode including: a collector; and a negative active material layer disposed on the collector, the negative active material layer including the composite.

One or more embodiments may include a lithium battery including: the negative electrode; a positive electrode including a positive active material; and an electrolyte.

One or more embodiments may include a method of manufacturing a negative electrode, the method including: milling a non-carbonaceous material and carbon nanotubes (CNTs), in the presence of an organic solvent, adding a carbonizable monomer and a polymerization catalyst to the resultant, to prepare polymer nanoparticles, and carbonizing the polymer nanoparticles, to thereby produce a composite; mixing the composite, a binder, and a solvent, to prepare a negative active material composition; and coating and drying the negative active material composition on a collector.

According to aspects of the present teachings, the carbon nanoparticles may include polymers formed from carbonized monomers.

According to aspects of the present teachings, the non-carbonaceous material includes at least one material selected from the group consisting of Si, silicon oxide (SiOx) (0<x<2), Si—Y (Y is selected from the group consisting of As, Sb, Bi, Cu, Ni, Mg, In, Zn, Ag, Al, and a combination thereof), and a mixture thereof.

According to aspects of the present teachings, the average particle size of the non-carbonaceous material may be in a range of about 10 to about 50 nm, for example, about 10 to about 30 nm.

Additional aspects and/or advantages of the present teachings will be set forth in part in the description which follows and, in part, will be obvious from the description, or may be learned by practice of the present teachings.

### BRIEF DESCRIPTION OF THE DRAWINGS

These and/or other aspects and advantages of the invention will become apparent and more readily appreciated from the following description of the exemplary embodiments, taken in conjunction with the accompanying drawings of which:

FIG. 1 is a schematic view of a negative active material, according to an exemplary embodiment;

FIG. 2 is a schematic cross-sectional view of a negative electrode, according to an exemplary embodiment;

FIG. 3 is a flowchart illustrating a method of manufacturing a negative electrode, according to an exemplary embodiment;

FIG. 4 is a schematic perspective view of a lithium secondary battery, according to an exemplary embodiment; and

FIG. 5 is a graph of cycle lifetime and coulomb efficiency of half-cells including negative electrodes manufactured according to Example 1 and Comparative Example 1.

### DETAILED DESCRIPTION

Reference will now be made in detail to the exemplary embodiments of the present teachings, which are illustrated in the accompanying drawings, wherein like reference numerals refer to the like elements throughout. The exemplary embodiments are described below, in order to explain the aspects of the present teachings, by referring to the figures.

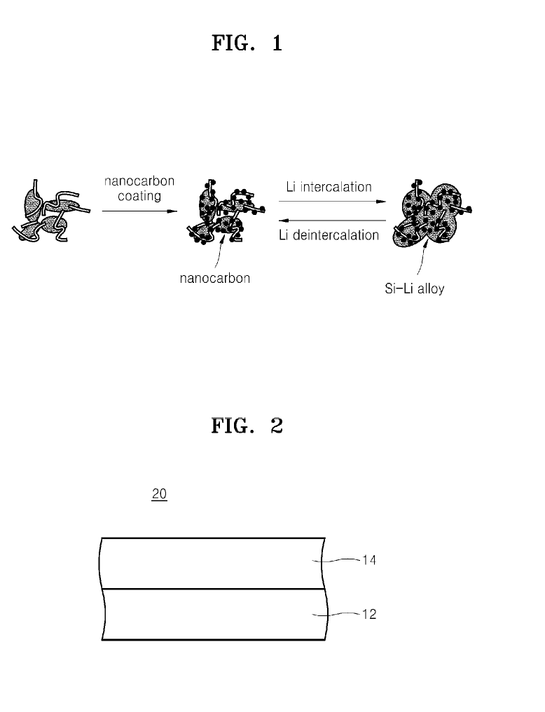

FIG. 1 is a schematic view of a negative active material, according to an exemplary embodiment of the present teachings. Referring to FIG. 1, the negative active material includes a composite that includes a non-carbonaceous material, carbon nanotubes (CNTs), and carbon nanoparticles. In the composite, the CNTs are dispersed on the surface of the non-carbonaceous material, and the carbon nanoparticles are coated on the resultant structure.

The carbon nanoparticles may be manufactured by any suitable process. For example, carbonizable monomers, such as pyrrole, divinylbenzene, or acrylonitrile, may be polymerized, and then the obtained polymer is carbonized by a suitable carbonization process.

Examples of the non-carbonaceous material include Si, silicon oxide (SiOₓ where 0<x<2), Si—Y, and a mixture thereof. In Si—Y, Y may be As, Sb, Bi, Cu, Ni, Mg, In, Zn, Ag, Al, or a combination thereof. When Si, SiOₓ, and Si—Y are used as the non-carbonaceous material, nano particles can be more easily formed by bead-milling or ball-milling, than when Sn or an Sn alloy is used as the non-carbonaceous material. The non-carbonaceous material may be referred to as a silicon-based material.

The non-carbonaceous material has a higher capacity than a carbonaceous negative active material. However, when the non-carbonaceous material is used alone, the electric conductivity of the non-carbonaceous material may be lower than that of a carbonaceous negative active material. Thus, battery performance may be degraded. In the current exemplary embodiment, the composite is used as the negative active material. Thus, electric conductivity can be improved.

The non-carbonaceous material may have an average particle size in a range of about 10 to about 50 nm, for example, about 10 to about 30 nm. If the non-carbonaceous material has non-spherical particles, the average particle size may refer to the length of the shortest axes of such particles. If the average particle size of the non-carbonaceous material is within these ranges, the binding force of the non-carbonaceous material with respect to CNTs may be increased, due to Van der Waals forces. If the average particle size of the non-carbonaceous material is greater than about 50 nm, charging and discharging rates may be increased, and thus, battery characteristics may be degraded.

In the negative active material the weight ratio of the non-carbonaceous material to the CNTs may range from about 2:1 to about 50:1, for example, about 5:1 to about 20:1. If the weight ratio of the non-carbonaceous material to the CNTs is less than about 2:1, too many irreversible reactions may occur when a lithium secondary battery including the negative active material is charged and/or discharged. On the other hand, if the weight ratio of the non-carbonaceous material to the CNTs is greater than about 50:1, the CNTs may not have a desired effect.

In the negative active material, the amount of the carbon nanoparticles may be in a range of about 10 to about 50 weight %, for example, about 20 to about 40 weight %, based on the total weight of the composite. If the amount of the carbon nanoparticles is too high, too many irreversible reactions may occur, when a lithium secondary battery including the negative active material is charged and/or discharged. On the other hand, if the amount of the carbon nanoparticles is too low, the binding effect may be insufficiently sustained.

FIG. 2 is a schematic view of a negative electrode 20, according to an exemplary embodiment. Referring to FIG. 2, the negative electrode 20 includes a collector 12 and a negative active material layer 14 disposed on the collector 12. The negative active material layer 14 includes the composite of FIG. 1.

The negative active material layer 14 may further include a binder. The binder may be a non-aqueous binder, such as polyvinidene fluoride (PVdF), or an aqueous binder having an electron donor group. Examples of the aqueous binder include polyethyleneimine, polyaniline, polythiophene, and styrene-butadiene rubber (SBR).

In the composite included in the negative active material layer 14, the mixture of the non-carbonaceous material and CNTs is coated with carbon nanoparticles, to increase a binding force between the non-carbonaceous material and the CNTs. Accordingly, the structure of the negative active material is sufficiently sustained, when a battery including the negative electrode 20 is charged and/or discharged. Thus the cycle lifetime of the battery may be increased. In addition, even when the negative electrode 20 suddenly swells or shrinks, due to a lithium-non-carbonaceous material generated by the non-carbonaceous material during charging and discharging, the structure of the negative active material is not changed. Thus, the disruption and/or micro-division of the negative active material can be prevented and a cycle lifetime of the battery may be increased.

The negative active material layer 14 may include a conductive material, in addition to the composite and the binder. The conductive material may be any suitable conductive material. Examples of the conductive material include: a carbonaceous material, such as natural graphite, artificial graphite, carbon black, acetylene black, ketjen black, or carbon fiber; a metal, such as copper, nickel, aluminum, or silver; a conductive polymer, such as a polyphenylen derivative; and a mixture thereof. Herein, the metal-based material may be in the form of a powder or a fiber. The amount of the conductive material may be appropriately controlled, according to an intended use thereof.

Conventionally, when a non-carbonaceous material, such as Si, is used as a negative active material, the crystallographic volume of the Si is suddenly increased or decreased, due to formation of a lithium-Si compound. Thus, cracks are formed in the negative active material, and the negative active material is finely divided. Thus, an electrical disconnection occurs, and a discharge capacity thereof may be significantly decreased, as a battery including the negative active material is repeatedly charged and discharged. However, the present negative electrode 20 does not have these problems.

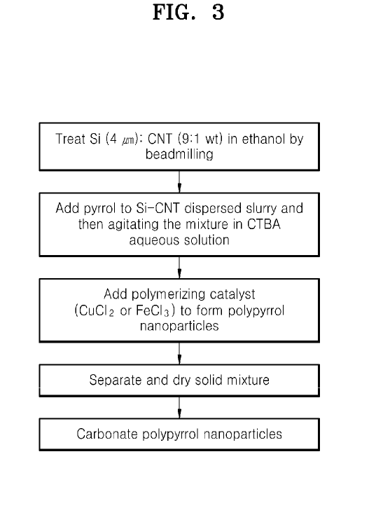

FIG. 3 is a flowchart illustrating a method of manufacturing a negative electrode, according to an exemplary embodiment. Referring to FIG. 3, a non-carbonaceous material and CNTs are milled in the presence of an organic solvent. Then, a carbonizable monomer and a polymerization catalyst are added thereto, to form polymer nanoparticles. Then the polymer nanoparticles are carbonized to form a negative active material. The milling may be bead-milling or ball-milling, for example. The organic solvent may be a solvent having a low volatility, such as an organic solvent having a flash point of about 15° C. or higher. Examples of the organic solvent include alcohols and alkanes, such as a C₁ to C₈ alcohol, or a C₆ to C₁₂ alkane. Examples of the C₁ to C₈ alcohol and the C₆ to C₁₂ alkane include ethanol, isopropanol, butanol, octanol, heptane, and dodecane. The organic solvent, however, is not limited to the solvents described above.

The mixing process may be performed at a rate of about 50 to about 60 Hz, for about 1 to about 2 hours. In this case, the non-carbonaceous material can be formed into nanoparticles having an average particle size in a range of about 10 to about 50 nm. If the non-carbonaceous material has non-spherical particles, the average particle size may refer to the length of the shortest axes of such particles. The particles are bound to the CNTs by Van der Waals forces. Then, the mixture of the non-carbonaceous material and the CNTs is mixed with a carbonizable monomer, such as pyrrole, divinylbenzene, or acrylonitrile, and a polymerization catalyst, such as CuCl₂ or FeCl₃. The resultant mixture is subjected to an emulsion polymerization, to form polymer nanoparticles, and the resultant solid mixture of non-carbonaceous material-carbon nanotubes-polymer nanoparticles is separated and dried.

The emulsion polymerization refers to a polymerizing method, in which a dispersing agent is added to an aqueous solution, to form micelles of the polymer nanoparticles. Then, the solid mixture is sintered at temperature of about 700° C., in an inert gas atmosphere, to carbonize the polymer nanoparticles, thereby forming a composite of carbon nanoparticles. When the carbon nanoparticles are formed using the carbonization process, nano-voids are also formed therein. Due to the nano-voids, any increase in volume occurring when lithium is intercalated into the non-carbonaceous material can be tolerated.

In the mixing process, the weight ratio of the non-carbonaceous material to the CNTs may be in a range of about 2:1 to about 50:1, for example, about 5:1 to about 10:1.

The negative active material and the binder are mixed in the presence of a solvent, to prepare a negative active material composition. In the mixing process, a conductive material may also be used. In this case, the amounts of the binder or the conductive material may be appropriately controlled. The amounts of the binder or the conductive material are not particularly limited.

The negative active material composition is coated on a collector and vacuum-dried, to form a negative active material layer and complete the manufacture of a negative electrode. The collector may be any material selected from the group consisting of a copper film, a nickel film, a stainless film, a titanium film, a nickel foam, a copper foam, and a conductive material-coated polymer substrate. Also, the collector may be manufactured by mixing materials that are used to form the collector, or by stacking the collectors.

The drying process may be performed at a temperature that is high enough to completely evaporate the solvent. The temperature of the drying process may vary according to the solvent. The drying process may be performed in a vacuum atmosphere.

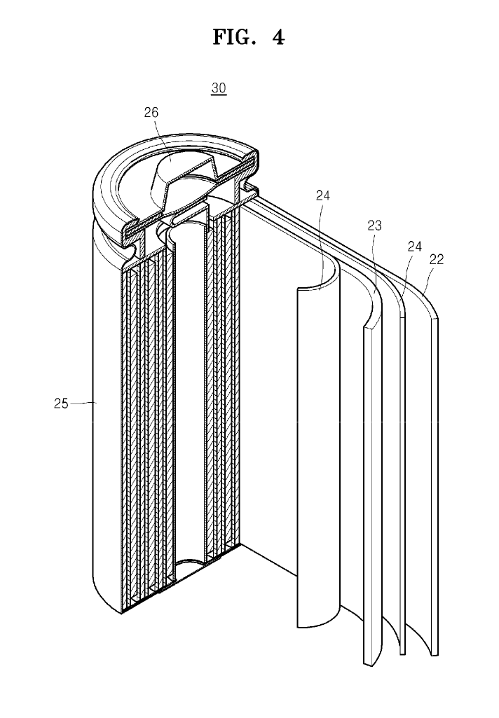

FIG. 4 is a schematic perspective view of a lithium secondary battery 30 according to an exemplary embodiment. Referring to FIG. 4, the lithium secondary battery 30 includes a positive electrode 23, a negative electrode 22, a separator 24 disposed between the positive electrode 23 and the negative electrode 22, an electrolyte (not shown), a battery container 25, and a sealing member 26 for sealing the battery container 25. Specifically, the positive electrode 23, the separator 24 and the negative electrode 22 are sequentially stacked and then wound in a cylindrical shape, impregnated with the electrolyte, and inserted into the battery container 25, thereby completing the manufacture of the lithium secondary battery 30.

The positive electrode 23 includes a collector and a positive active material layer disposed on the collector. The positive active material layer includes a positive active material. The positive active material may be a compound that allows lithium to be reversibly intercalated, that is, a lithiated intercalation compound. For example, the positive active material may include at least one lithium-metal composite oxide including a metal selected from the group consisting of cobalt, manganese, nickel, and a combination thereof.

Such lithium-metal composite oxides may have the following chemical formulae: LiₐA_{1-b}X_{b}D₂ where 0.95≦a≦1.1 and 0≦b≦0.5; LiₐE_{1-b}X_{b}O_{2-c}D_{c}, where 0.95≦a≦1.1, 0≦b≦0.5, and 0≦c≦0.05; LiE_{2-b}X_{b}O_{4-c}D_{c}, where 0≦b≦0.5, and 0≦c≦0.05; LiₐNi_{1-b-c}Co_{b}BcD_{α}, where 0.95≦a≦1.1, 0≦b≦0.5, 0≦c≦0.05, and 0<α≦2; LiₐNi_{1-b-c}Co_{b}X_{c}O_{2-α}M_{α}, where 0.95≦a≦1.1, 0≦b≦0.5, 0≦c≦0.05, and 0<α<2; LiₐNi_{1-b-c}Co_{b}X_{c}O_{2-α}M₂, where 0.95≦a≦1.1, 0≦b≦0.5, 0≦c≦0.05, and 0<α<2; LiₐNi_{1-b-c}Mn_{b}X_{c}Dₐ, where 0.95≦a≦1.1, 0≦b≦0.5, 0≦c≦0.05, and 0<α≦2; LiₐNi_{1-b-c}Mn_{b}X_{c}O_{2-α}M_{α}, where 0.95≦a≦1.1, 0≦b≦0.5, 0≦c≦0.05, and 0<α<2; LiₐNi_{1-b-c}Mn_{b}X_{c}O_{2-α}M₂, where 0.95≦a≦1.1, 0≦b≦0.5, 0≦c≦0.05, and 0<α<2; LiₐNi_{b}E_{c}G_{d}O₂, where 0.90≦a≦1.1, 0≦b≦0.9, 0≦c≦0.5, and 0.001≦d≦0.1; LiₐNi_{b}Co_{c}Mn_{d}GₑO₂, where 0.90≦a≦1.1, 0≦b≦0.9, 0≦c≦0.5, 0≦d≦0.5, and 0.001≦e≦0.1; LiₐNiG_{b}O₂, where 0.90≦a≦1.1 and 0.001≦b≦0.1; LiₐCoG_{b}O₂, where 0.90≦a≦1.1, and 0.001≦b≦0.1; LiₐMnG_{b}O₂ where 0.90≦a≦1.1, and 0.001≦b≦0.1; LiₐMn₂G_{b}O₄, where 0.90≦a≦1.1, and 0.001≦b≦0.1; QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); and LiFePO₄.

In these chemical formulae: A is selected from the group consisting of Ni, Co, Mn, and a combination thereof; X is selected from the group consisting of Al, Ni, Co, Mn, Cr, Fe, Mg, Sr, V, rare-earth elements, and a combination thereof; D is selected from the group consisting of O, F, S, P, and a combination thereof; E is selected from the group consisting of Co, Mn, and a combination thereof; M is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The lithium-metal composite oxides may include a coating. The positive active material may also be a mixture of coated and uncoated lithium-metal composite oxides. The coating may include at least one element selected from the group consisting of Mg, Al, Co, K, Na, Ca, Si, Ti, V, Sn, Ge, Ga, B, As, Zr or a mixture thereof. The coating element may be in the form of a hydroxide, an oxyhydroxide, an oxycarbonate, or a hydroxycarbonate. The coating layer may be amorphous or crystalloid.

The lithium-metal composite oxides may be coated using any method that does not affect properties of the positive active material. Such a method may be, for example, a spray coating method, an immersion method, or the like.

The positive active material layer may further include a binder and a conductive material. The binder binds together particles of the positive active material and attaches the positive active material to the collector. Examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, and nylon. However, the binder is not limited to these materials.

The conductive material increases the conductivity of the positive electrode 23. The conductive material may be any conductive material that does not cause a chemical change in a battery using the conductive material. Examples of the conductive material include: a carbonaceous material, such as natural graphite, artificial graphite, carbon black, acetylene black, ketjen black, or carbon fiber; a metal such as copper, nickel, aluminum, or silver; a conductive polymer such as a polyphenylen derivative; and a mixture thereof. Herein, the metal may be in the form of a powder or a fiber. The collector may be formed of Al. However, the collector can also be formed of other materials.

In a method of manufacturing the positive electrode 23, the positive active material, the conductive material, and the binder are mixed in a solvent, to prepare a positive active material composition that is coated on the collector. Since the method is well known in the art, the method will not be described in detail. The solvent may be, but is not limited to, N-methylpyrrolidone.

The electrolyte includes a non-aqueous organic solvent and a lithium salt. The non-aqueous organic solvent may act as a medium through which ions involved in an electrochemical reaction of the lithium battery 30 may be transported.

The non-aqueous organic solvent may be a carbonate-based solvent, an ester-based solvent, an ether-based solvent, a ketone-based solvent, an alcohol-based solvent, or an aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC). Examples of the ester-based solvent include methyl acetate, ethyl acetate, n-propyl acetate, dimethylacetate, methylpropionate, ethylpropionate, γ-butyrolactone, decanolide, valerolactone, mevalonolactone, and caprolactone. Examples of the ether-based solvent include dibutylether, tetraglyme, diglyme, dimethoxyethane, 2-methyltetrahydrofurane, and tetrahydrofurane. Examples of the ketone-based solvent include cyclohexanone. Examples of the alcohol-based solvent include ethylalcohol and isopropyl alcohol. Examples of the aprotic solvent include: nitriles such as R—CN, where R is a linear, branched, or cyclic C2 to 20 hydrocarbon group and has a double-bond direction ring or an ether bond; amides such as dimethylformamide; and dioxolane-based sulfolanes such as a 1,3-dioxolane sulfolane.

The non-aqueous organic solvents may be used alone or in combination. If the non-aqueous organic solvents are used in combination, the mixture ratio may be appropriately controlled, according to a desired battery performance.

The lithium salt is dissolved in the non-aqueous organic solvent, acts as a lithium ion supplier in the lithium battery 30, and promotes the movement of lithium ions between the positive electrode 23 and the negative electrode 22. The lithium salt may include at least one supporting electrolytic salt selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂[lithium bis(oxalato) borate; LiBOB]. The concentration of the lithium salt may be in a range of about 0.1 to about 2.0 M. If the concentration of the lithium salt is within this range, the electrolyte has appropriate levels of conductivity and viscosity, and thus, has excellent electrolytic performance.

Examples of the separator 24 include a polyethylene single layer, a polypropylene single layer, a polyvinylidene fluoride single layer, a combination thereof, a polyethylene/polypropylene double-layered structure, a polyethylene/polypropylene/polyethylene triple-layered structure, and a polypropylene/polyethylene/polypropylene triple-layered structure. The separator 24 may be omitted in some embodiments.

Lithium batteries are classified into lithium ion batteries, lithium ion polymer batteries and lithium polymer batteries, according to the separator used and the electrolyte used therein. Lithium batteries are also classified into cylindrical lithium batteries, rectangular lithium batteries, coin-like lithium batteries, and pouch-like lithium batteries, according to the shape thereof. Lithium batteries are further classified into bulky lithium batteries and thin lithium batteries, according to the size thereof. The lithium battery 30 can be a primary battery or a secondary battery.

Hereinafter, examples of the present teachings and comparative examples will be described in detail. However, the present invention is not limited to these examples.

### EXAMPLE 1

Si powder (average particle size 4 μm) and CNTs were mixed at a weight ratio of 90:10, by bead-milling, in the presence of ethanol, thereby preparing an Si-CNT slurry. The mixing process was performed at a rate of 55 Hz, for one hour.

Pyrrole (carbonizable monomer), was added to the Si-CNT slurry, and then a cetyl trimethylammonium bromide (CTAB) aqueous solution was added thereto. The resultant solution was then mixed. Then, FeCl₃ (polymerization catalyst) was added to the mixed solution, to perform emulsion polymerization, to polymerize the monomers, which formed micelles, thereby producing polymer nanoparticles. The resultant solid mixture of the Si-CNTs-polymer nanoparticles was separated, dried, and then sintered under an N₂ gas atmosphere at 700° C., for 2 hours, to carbonize the polymer nanoparticles, thereby manufacturing a composite of Si-CNT-carbon nanoparticles, having Si particles with an average particle size of 15 nm, as measured using X-ray diffraction (XRD) and the Scherrer equation.

A polyvinidene fluoride (PVDF) binder was added to the composite, to prepare a negative active material slurry. The amount of the composite was 90 weight % (65 weight % of SiOₓ, 7 weight % of CNTs, and 18 weight % of carbon nanoparticles) and the amount of the binder was 10 weight %.

The negative active material slurry was coated on a copper collector and dried under vacuum conditions at 120° C., for 2 hours, thereby manufacturing a negative electrode.

### COMPARATIVE EXAMPLE 1

A negative electrode was manufactured in the same manner as in Example 1, except that carbon nanoparticles were not included in the composite, and the amount of the composite (Si-carbon nanotubes) was 85 weight % (76 weight % of SiOₓ and 9 weight % of CNTs) and the amount of the binder was 15 weight %.

### Experimental Examples: Battery Characteristics Evaluation

1) Manufacture of Test Batteries

A coin-type half-battery was manufactured by using each of the negative electrodes manufactured according to Example 1 and Comparative Example 1, a lithium metal constituting a counter electrode, and an electrolyte. The electrolyte was prepared by dissolving 1.3M LiPF₆ in a solvent of ethylene carbonate and dimethyl carbonate, at a volume ratio of 1:1.

2) Battery Characteristics: Cycle Lifetime and Coulomb Efficiency

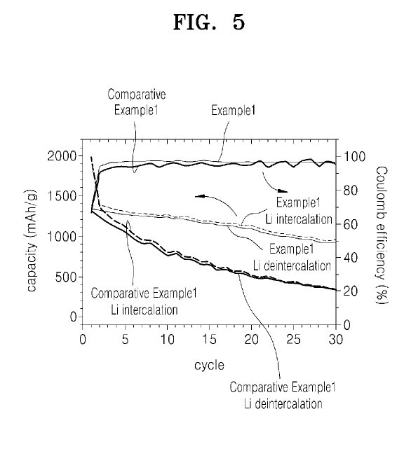

The half-batteries including the negative electrodes manufactured according to Example 1 and Comparative Example 1 were charged and discharged 30 times at 0.1 C, to evaluate charge/discharge capacities and coulomb efficiencies. FIG. 5 is a graph of cycle lifetime and coulomb efficiency of the half-cells according to Example 1 and Comparative Example 1. As illustrated in FIG. 5, the coulomb efficiency and cycle lifetime characteristics of the half-battery according to Example 1 were substantially improved, as compared to the half-battery according to Comparative Example 1.

As described above, according to the one or more of the above embodiments, a negative electrode includes a negative active material that includes a non-carbonaceous material, CNTs, and carbon nanoparticles coated on a mixture of the non-carbonaceous material and the CNTs, to enhance a binding force between the non-carbonaceous material and the CNTs. Accordingly, when a battery including the negative electrode is charged and discharged, the structure of the negative active material is sustained, and thus, a long cycle lifetime can be obtained.

Although a few exemplary embodiments of the present teachings have been shown and described, it would be appreciated by those skilled in the art that changes may be made in these exemplary embodiments, without departing from the principles and spirit of the present teachings, the scope of which is defined in the claims and their equivalents.

What is claimed is:

1. A negative active material comprising a composite that comprises a non-carbonaceous material, carbon nanotubes (CNTs), and carbon nanoparticles.

2. The negative active material of claim 1, wherein the CNTs are dispersed on a surface of the non-carbonaceous material, and the carbon nanoparticles are coated on the CNTs and the non-carbonaceous material.

3. The negative active material of claim 1, wherein the carbon nanoparticles comprise polymers formed of carbonized monomers.

4. The negative active material of claim 3, wherein the carbonized monomers are formed by carbonizing pyrrol, divinylbenzene, or acrylonitrile monomers.

5. The negative active material of claim 1, wherein a weight ratio of the non-carbonaceous material to the CNTs is in a range of from about 2:1 to about 50:1.

6. The negative active material of claim 1, wherein the amount of the carbon nanoparticles is in a range of from about 10 weight % to about 50 weight %, based on the total weight of the composite.

7. The negative active material of claim 1, wherein the non-carbonaceous material comprises at least one material selected from the group consisting of Si, silicon oxide (SiOₓ where 0<x<2), Si—Y, and a mixture thereof, wherein Y is selected from the group consisting of As, Sb, Bi, Cu, Ni, Mg, In, Zn, Ag, Al, and a combination thereof.

8. The negative active material of claim 1, wherein the average particle size of the non-carbonaceous material is in a range of about 10 nm to about 50 nm.

9. A negative electrode comprising:
a collector; and
an active material layer disposed on the collector, comprising the negative active material of claim 1.

10. A lithium battery comprising:
the negative electrode of claim 9;
a positive electrode comprising a positive active material; and
an electrolyte.

11. A method of manufacturing a negative electrode, the method comprising:
milling a non-carbonaceous material and carbon nanotubes (CNTs), in an organic solvent, to prepare a mixture,
adding carbonizable monomers and a polymerization catalyst to the mixture, to prepare polymer nanoparticles, and
carbonizing the polymer nanoparticles, to produce a composite material;
mixing the composite material, a binder, and a solvent, to prepare a negative active material composition; and
coating and drying the negative active material composition on a collector.

12. The method of claim 11, wherein the mixing is performed from about 50 Hz to about 60 Hz.

13. The method of claim 11, wherein the mixing is performed for from about 1 hour to about 2 hours.

14. The method of claim 11, wherein the polymer nanoparticles are formed by an emulsion polymerization, in which the carbonizable monomers form micelles, to form a polymer.

15. The method of claim 11, wherein the organic solvent comprises an alcohol or an alkane.

16. A negative active material comprising a composite comprising:
particles of a silicon-based material;
carbon nanotubes (CNTs) attached to the silicon-based material, and
carbon nanoparticles coated on the CNTs and the silicon-based material.

17. The negative active material of claim 16, wherein the average size of the particles of the silicon-based material is in a range of from about 10 nm to about 50 nm.

18. The negative active material of claim 16, wherein the weight ratio of the silicon-based material to the CNTs is in a range of from about 5:1 to about 20:1.

19. The negative active material of claim 16, further comprising a binder, wherein the amount of the composite was 90 weight % (65 weight % of the silicon-based material, 7 weight % of the CNTs, and 18 weight % of the carbon nanoparticles), and the amount of the binder was 10 weight %, based on the total weight of the negative active material.

20. The negative active material of claim 16, wherein the silicon-based material comprises at least one material selected from the group consisting of Si, silicon oxide (SiOₓ where 0<x<2), Si—Y, and a mixture thereof, wherein Y is selected from the group consisting of As, Sb, Bi, Cu, Ni, Mg, In, Zn, Ag, Al, and a combination thereof.
